(19) United States
(12) Patent Application Publication
(10) Pub. No.: US 2005/0162404 A1
(43) Pub. Date: Jul. 28, 2005

(54) Apparatus with one or more capacitive touchpads as interface

(76) Inventors: Yen-Chang Chiu, Linkou Shiang (TW); Yung-Lieh Chien, Taoyuan City (TW); Cheng-Hao Tang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/028,210

(22) Filed: Jan. 4, 2005

(30) Foreign Application Priority Data
Jan. 8, 2004 (TW) 093100488

(51) Int. Cl. G09G 5/00

(52) U.S. Cl. 345/173

(57) ABSTRACT

An apparatus comprises a case, one or more capacitive touchpads mounted on the case for serving as the input interface of the apparatus, and a microprocessor within the case connected to the capacitive touchpads. Each of the capacitive pads generates a signal representative of capacitance change in response to a touch thereon, and the microprocessor determines the displacement, moving speed, relative position, or continuing and discontinuing time of the touch from the signal representative of capacitance change, to accordingly generate corresponding output as a button, Z-axis or scrolling signal.

### FIELD OF THE INVENTION

The present invention is related generally to a peripheral apparatus of a computer system, and more particularly, to an apparatus with one or more capacitive touchpads as interface of the apparatus.

### BACKGROUND OF THE INVENTION

Peripheral apparatus are important equipments for a computer system, which are used to implement the input/output (I/O) functions or to expend the functions of a computer system. In particular, keyboard and mouse have become fundamental peripheral apparatus of a computer system. As a human-machine interface, keyboard and mouse have been improved continuously, to have smaller volume, lighter weight, and lower cost to provide users more functions and higher efficiency.

A conventional mouse has two, three or more buttons to generate button signals in response to the clicks thereon for supplying to the system host. An improved mouse additionally has Z-axis mechanism using a wheel to generate Z-axis signal in response to the scrolling of the wheel for providing the control of scrolling and/or the acceleration of scrolling on the window of a Windows system. In such mechanical Z-axis apparatus, digital or analog signal is generated when the wheel is scrolled, and this digital or analog signal is sensed by a microprocessor to determine the displacement and its direction of the Z-axis mechanism. A further improvement is to connect the wheel of the Z-axis mechanism with an additional button, such that pressing the wheel will generate a control signal to implement a new function, such as continuous scrolling of the window.

FIG. 1 shows a conventional mouse 10 that comprises buttons 12 and 14 and a wheel 13 therebetween. According to the signal generated by scrolling the wheel 13 is digital or analog, a conventional Z-axis mechanism of a mouse is implemented with mechanical wheel and optical wheel. A digital mechanical Z-axis mechanism has a polygon structure in the axis of the wheel, incorporating with an encoder to generate a digital signal of 0s and 1s, by plucking a metal switch within the encoder during the wheel is scrolled forward and backward, to determine the information contained in the resulted Z-axis signal, for example referring to the mouse-associated Z-axis encoder disclosed by U.S. Pat. No. 6,285,355 issued to Chang. After the mouse is used for a time period, however, a mechanical Z-axis mechanism will have abnormal scrolling of the wheel due to the wear out of the wheel and its axis, and the metal switch within the encoder will deteriorate with poor contacting and bouncing, which will introduce errors in the generated signals. In addition, the wheel mechanism occupies large space that is disadvantageous to the mechanism design of a mouse, and thus restricts the applications. Furthermore, a wheel mechanism provides only one direction of Z-axis scrolling, and therefore, a second wheel mechanism is required if another direction of Z-axis scrolling is desired, thereby increasing the occupied space and manufacturing cost.

On the other hand, an optical digital wheel mechanism comprises a wheel and a pair of optical emitter and receiver on the opposite sides of the wheel to align to each other, and the wheel has transparent areas and opaque areas alternatively intersecting to each other. The transparent area allows the light from the optical emitter to pass through, while the opaque area does not. When a user scrolls the wheel, the light emitted by the emitter will pass through the transparent areas to reach to the receiver, or be blocked by the opaque areas, so as to generate a digital signal of 1s or 0s to determine the information contained in the resulted Z-axis signal, for example referring to the encoder wheel module and circuit board arrangement for an optical mouse with scrolling function disclosed by U.S. Pat. No. 6,344,643 issued to Chen. If the wheel is not precisely positioned, jitters will be occurred in the signals generated by the receiver, and errors are easily introduced in the signals. In addition, the optical emitter and receiver have to be continuously lighted up and thus consume huge electric power. After a time period of usage, degradation of the optical emitter and receiver will cause the optical signal generated by the emitter and the response signal generated by the receiver to have level deviations. During the fabrication of an optical wheel mechanism, adjustment is required for the current-limiting resistor for the emitter and for the optical positioning between all the components, and thus the work time is increased. An optical wheel mechanism also occupies large space and thus limits the mechanism design of the mouse and the applications. Likewise, a wheel mechanism provides only one direction of Z-axis scrolling, and therefore, a second wheel mechanism is required if another direction of Z-axis scrolling is desired, thereby increasing the occupied space and manufacturing cost.

An analog wheel mechanism has similar structure and operational principles as the digital one, only that it generates an analog signal instead of digital signal. Due to the similar structure and operational principles, it is disadvantageous as a digital one.

Moreover, the buttons and the wheel mechanism of a conventional mouse require the user to apply more force by his fingers for operations, and long-time usage may cause the fingers fatigue, even damaged. Particularly, in the applications of the small mouse for kids, the conventional wheel mechanism is disadvantageous to scale down for a mouse, and the pressing force needed to be applied on the buttons and wheel mechanism are disadvantageous for kids to operate the mouse. In order to reduce the force needed to press the button, a large button mechanism is necessary for a mouse to provide longer force arm, and it is again disadvantageous to scale down for a mouse.

Scrolling mechanism is also applied on keyboards. FIG. 2 shows a conventional keyboard 16 that comprises a tracking ball 18 in addition to the keys. Scrolling the tracking ball 18 generates a digital or analog signal to provide the scrolling control of a window. The structure and operational principles of this scrolling apparatus is also similar to that of the wheel mechanism in the aforementioned mouse, it is thus disadvantageous hereto for the same reasons.

Although several arts have been proposed for improvement to the Z-axis and scrolling apparatus in conventional mice and keyboards, their mechanisms and operational principles are still within the scope of the aforementioned ones, and thus the drawbacks could not be removed. Accordingly, it is desired a mouse, keyboard and other peripheral apparatus with novel interface to solve the problems cited in the aforementioned arts.

### SUMMARY OF THE INVENTION

One object of the present invention is to provide an apparatus with capacitive touchpad as interface to prolong the lifetime thereof.

Another object of the present invention is to provide an apparatus with capacitive touchpad as interface to scale down the volume thereof.

A further object of the present invention is to provide an apparatus with capacitive touchpad as interface to reduce the cost therefor.

Yet another object of the present invention is to provide an apparatus with capacitive touchpad as interface to lower the consuming power therewith.

Still another object of the present invention is to provide an apparatus with capacitive touchpad as interface to improve the manufacturing yield therefor.

Still yet another of the present invention is to provide an apparatus with capacitive touchpad as interface to shorten the manufacturing time therefor.

Still a further object of the present invention is to provide an apparatus with capacitive touchpad as interface to release the user's fingers from force to operate therewith.

According to the present invention, an apparatus comprises one or more capacitive touchpads mounted on a case as input interface, and a microprocessor within the case connected to the capacitive touchpads. Each of the capacitive touchpads generates a signal representative of capacitance change in response to a touch thereon, and the microprocessor determines the displacement, moving speed, relative position, or continuing and discontinuing time of the touch from the signal representative of capacitance change, to accordingly generate corresponding output as a button, Z-axis or scrolling signal. The Z-axis and scrolling signals could provide the control of scrolling on a window or acceleration of scrolling on a window.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional mouse having a Z-axis mechanism thereon;

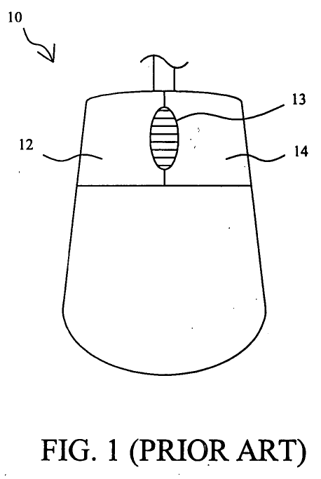

FIG. 2 shows a conventional keyboard having a tracking ball thereon;

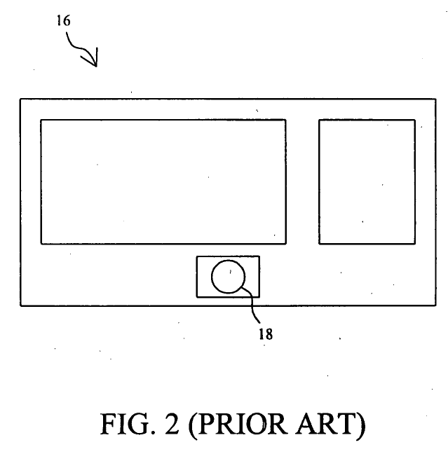

FIG. 3 shows a schematic diagram of the first embodiment for a mouse according to the present invention;

FIG. 4 shows a schematic diagram of the second embodiment for a mouse according to the present invention;

FIG. 5 shows a schematic diagram of the third embodiment for a mouse according to the present invention;

FIG. 6 shows a functional block diagram for the various embodiments of FIGS. 3-5;

FIG. 7 shows a schematic diagram of an arrangement for the various embodiments of FIGS. 3-5;

FIG. 8 shows a schematic diagram of the first embodiment for a keyboard according to the present invention; and

FIG. 9 shows a schematic diagram of the second embodiment for a keyboard according to the present invention.

### DETAILED DESCRIPTION OF THE INVENTION

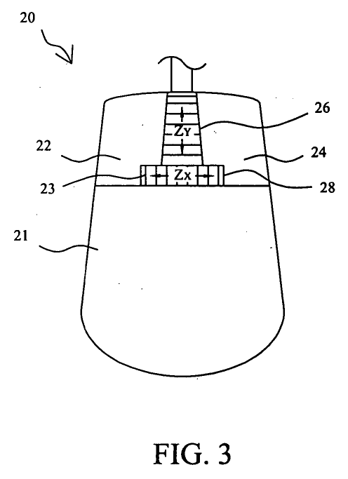

FIG. 3 shows a schematic diagram of the first embodiment for a mouse according to the present invention. On a case 21 of a mouse 20, capacitive touchpad 26 extending in the vertical direction and capacitive touchpad 28 extending in the horizontal direction to serve as Z_{Y}-axis and Z_{X}-axis 28 are mounted between a left button 22 and a right button 24. In other embodiments, the Z-axis mechanisms 26 and 28 may be mounted on the case 21 at other positions. The left button 22 and right button 24 have the same function as a typical mouse, and button switch mechanism is employed for them both. In a preferred embodiment, the Z_{Y}-axis 26 is provided for the control of scrolling on a window in the vertical direction, and the Z_{X}-axis 28 is provided for the control of scrolling on the window in the horizontal direction. Uniform profile or saw structure 23 with equally spaced teeth are formed on the surfaces of the Z_{Y}-axis 26 and Z_{X}-axis 28 to enhance the touch feel when user's fingers move thereon, and to easily control the scrolling movement of the window in vertical or horizontal direction. In other embodiments, the saw structure 23 may have teeth with varying spacing therebetween for alternative functions. According to the general principles of a capacitive touchpad, when the user's finger moves on the Z_{Y}-axis 26 or Z_{X}-axis 28, the signal representative of capacitance change resulted from the finger's touch could be used to determine the displacement; moving speed and relative position of the finger to generate corresponding Z-axis signal. If such Z-axis signal is used to provide for the control of scrolling on a window in the vertical and horizontal directions, the direction and displacement of the finger's movement can be used to determine the direction and the displacement of the scrolling on the window, and the moving speed of the finger can be used to determine the acceleration of the scrolling on the window. In other embodiments, alternative function is provided by using the continuing and discontinuing time of a touch on the Z_{Y}-axis 26 or Z_{X}-axis 28. For example, a double click on the Z_{Y}-axis 26 or Z_{X}-axis 28 will generate an additional button signal to implement a function key or a hot key.

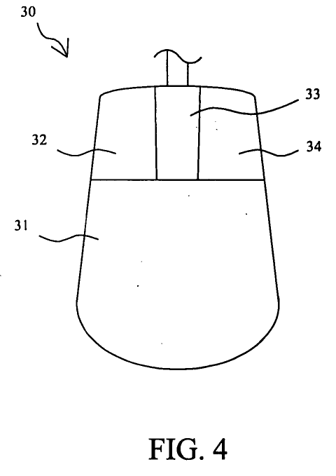

FIG. 4 shows a schematic diagram of the second embodiment for a mouse according to the present invention. On the case 31 of a mouse 30, there are three independent capacitive touchpads 32, 33 and 34 mounted thereon for a left button, middle button and right button, respectively. In other embodiments, one capacitive touchpad is defined three or more regions thereon, each of them served as a key. In a preferred embodiment, one click on any of the buttons 32, 33 and 34 is determined by the continuing and discontinuing time of a touch thereon. For example, if the time interval between two touches on the button 32 or 34 falls in a predetermined range, it is determined to be a single click of the corresponding button, and a quick double touches on the button 33 is determined to be a single click of the button 33. The middle button 33 may be used to define a function key or a hot key.

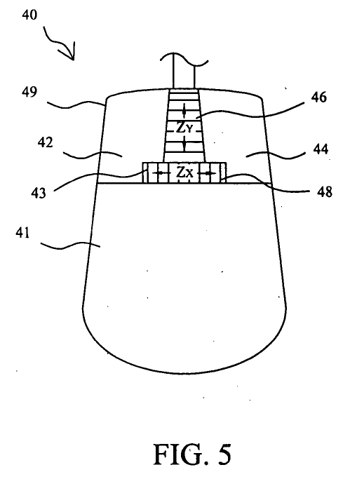

FIG. 5 shows a schematic diagram of the third embodiment for a mouse according to the present invention. A single capacitive touchpad 49 is mounted on the case 41 of a mouse 40, and has several patterns printed thereon to indicate a left button area 42, a right button area 44, and Z_{Y}-axis area 46 and Z_{X}-axis area 48 therebetween. A small protruding saw 43 is printed on the Z_{Y}-axis area 46 and Z_{X}-axis area 48 to enhance the touch feel and for easy control of movement. The function and operation of the left button area 42 and right button area 44 are the same as the left button 32 and right button 34 of the mouse 30 shown in FIG. 4. The Z_{Y}-axis area 46 extends in the vertical direction, and the Z_{X}-axis area 48 extends in the horizontal direction, whose function and operation are the same as the Z_{Y}-axis 26 and Z_{X}-axis 28 of the mouse 20 shown in FIG. 3.

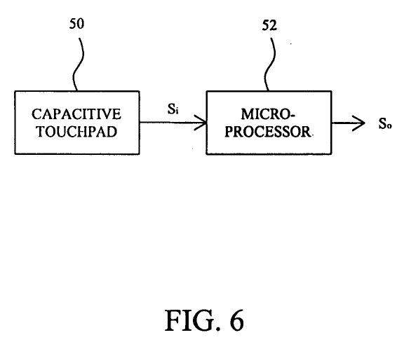

FIG. 6 shows a functional block diagram for the various embodiments shown in FIGS. 3-5, which is used to execute the operations of the mice 20, 30 and 40 with their capacitive touchpads as interface for inputs of button and Z-axis. In FIG. 6, the capacitive touchpad 50 represents any one of the buttons and Z-axis provided by the capacitive touchpads on the mice 20, 30 and 40, which generates a signal representative of capacitance change, designated by Sᵢ, in response to a touch of a finger on it. The microprocessor 52 receives the signal Sᵢ and analyzes thereto to determine the displacement, moving speed, relative position, or continuing and discontinuing time of the touch, and accordingly generates a corresponding output Sₒ to be a button or Z-axis signal. When the capacitive touchpad 50 provides a button function, it is only determined whether or not a touch is present and, if any, the continuing time of the touch. When the capacitive touchpad 50 provides a Z-axis function, it is only determined the touch in one-dimensional movement. Both of such button and Z-axis functions need easier operations than that of a typical capacitive touchpad, and thus the required hardware and software are simpler than that for a typical capacitive touchpad and the cost is also lower. Since no optical detection is used, the power consumed by such mouse with capacitive touchpad as interface is extremely low.

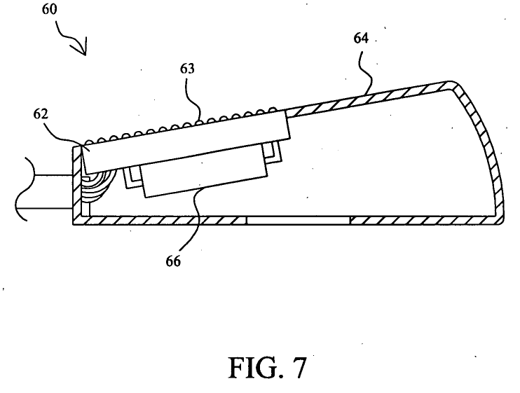

FIG. 7 shows a schematic diagram of an arrangement for the various embodiments shown in FIGS. 3-5. In a mouse 60, a capacitive touchpad 62 is mounted on the case 64, and a microprocessor chip 66 is mounted on the backside of the capacitive touchpad 62. The Z-axis provided by the capacitive touchpad 62 has a saw structure 63 thereon. For the capacitive touchpad 62, any known capacitive touchpad technologies or any their improvement could be applied. Since the capacitive touchpad 62 has a thickness of only one printed circuit board (PCB), the mouse 60 could be extremely small and thin. In addition, only very small area is required to provide several buttons and Z-axis. The capacitive touchpad will not wear out even after a long-time usage and has a very long lifetime. For usage of a capacitive touchpad, only touch is required and thus a tiny force is enough for the user to operate. If a saw structure is formed on the surface of the capacitive touchpad, the touch feel of the finger thereon is enhanced and it helps to easily control the movement of scrolling on a window. If the surface of the capacitive touchpad is remained smooth as a typical one, the smooth surface is helpful for the user's finger to slip thereon easily. Moreover, the mouse according to the present invention does not need mold such as one for a mechanism wheel, and no more expensive instruments or optical components are required, thereby reducing the cost dramatically. In the fabrication of a mouse according to the present invention, neither adjustment for current-limiting resistor nor optical positioning calibration is required, and therefore, the production becomes easier, the production time is shortened, and the yield is increased. Light, thin, short, small, and easy to use make the mouse of the present invention more advantageous for miniaturization applications, especially for kids' mouse.

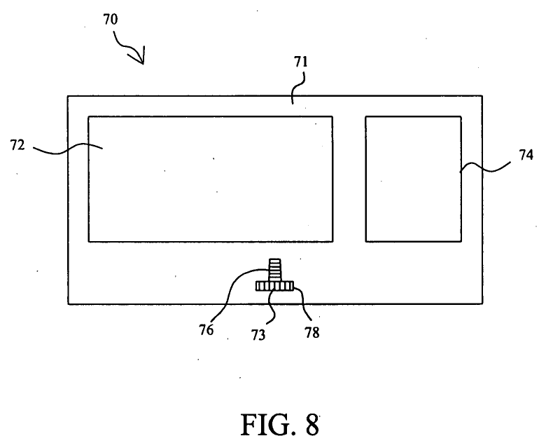

FIG. 8 shows a schematic diagram of the first embodiment for a keyboard according to the present invention. On the case 71 of a keyboard 70, in addition to the normal key area 72 and numerical key area 74, a capacitive touchpad 76 extending in the vertical direction and a capacitive touchpad 78 extending in the horizontal direction are mounted to serve as a vertical scroll bar 76 and a horizontal scroll bar 78, respectively, and a saw structure 73 is formed on the surfaces of the vertical scroll bar 76 and horizontal scroll bar 78. The vertical and horizontal scroll bars 76 and 78 provide the control of scrolling on a window in the vertical and horizontal directions, respectively, and the principle and operations are the same as that explained for the previous embodiments. In other embodiments, alternative function is provided by using the continuing and discontinuing time of a touch on the vertical scroll bar 26 or horizontal scroll bar 28. For example, a double click on the vertical scroll bar 26 or horizontal scroll bar 28 will generate an additional button signal to implement a function key or a hot key.

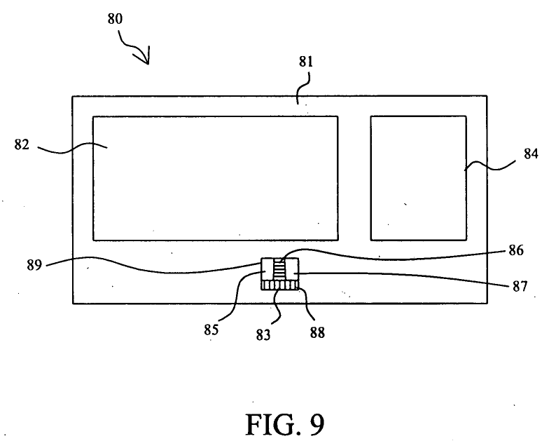

FIG. 9 shows a schematic diagram of the second embodiment for a keyboard according to the present invention. On the case 81 of a keyboard 80, in addition to the normal key area 82 and numerical key area 84, a capacitive touchpad 89 is mounted, on which several regions are defined and have corresponding patterns printed thereon for indications, including a vertical scroll bar 86, a horizontal scroll bar 88, left button 85, and right button 87. Likewise, the vertical scroll bar 86 and horizontal scroll bar 88 each has a saw structure 83 thereon, and the functions and operations of the scroll bars 86 and 88 and buttons 85 and 87 provided by the capacitive touchpad 89 are the same as that of the capacitive touchpad 49 shown in FIG. 5. In other embodiments, the button patterns 85 and 87 could be used to define function keys or hot keys. Similarly, using a capacitive touchpad on a keyboard as interface for the scroll bars and buttons has the advantages of small space, long lifetime, low power consumption, low cost, easy to manufacture, high production yield, short production time, and easy to use.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. An apparatus comprising:
a mouse case;
a capacitive touchpad mounted on the mouse case, and for generating a signal representative of capacitance change in response to a touch thereon; and
a microprocessor within the mouse case, and connected to the capacitive touchpad for generating a Z-axis signal in response to the signal representative of capacitance change.

2. The apparatus of claim 1, wherein the Z-axis signal comprises an information of displacement, moving speed, relative position, or continuing and discontinuing time of the touch.

3. The apparatus of claim 1, wherein the Z-axis signal comprises an information of scrolling on a window.

4. The apparatus of claim 1, wherein the Z-axis signal comprises an information of acceleration of scrolling on a window.

5. The apparatus of claim 1, wherein the Z-axis signal comprises an information of button.

6. The apparatus of claim 5, wherein the information of button defines a function key or hot key.

7. The apparatus of claim 1, wherein the capacitive touchpad comprises a saw structure thereon.

8. An apparatus comprising:
a mouse case;
a first capacitive touchpad mounted on the mouse case, and for generating a first signal representative of capacitance change in response to a first touch thereon;
a second capacitive touchpad mounted on the mouse case, and for generating a second signal representative of capacitance change in response to a second touch thereon; and
a microprocessor within the mouse case, and connected to the first and second capacitive touchpads for generating a first Z-axis signal in response to the first signal representative of capacitance change and a second Z-axis signal in response to the second signal representative of capacitance change, respectively.

9. The apparatus of claim 8, wherein the first Z-axis signal comprises a first information of displacement, moving speed, relative position, or continuing and discontinuing time of the first touch, and the second Z-axis signal comprises a second information of displacement, moving speed, relative position, or continuing and discontinuing time of the second touch.

10. The apparatus of claim 8, wherein the first Z-axis signal comprises a first information of scrolling on a window in a first direction, and the second Z-axis signal comprises a second information of scrolling on the window in a second direction.

11. The apparatus of claim 10, wherein the first and second directions are defined to be a vertical direction and a horizontal direction of the window, respectively.

12. The apparatus of claim 8, wherein the first Z-axis signal comprises a first information of acceleration of scrolling on a window in a first direction, and the second Z-axis signal comprises a second information of acceleration of scrolling on the window in a second direction.

13. The apparatus of claim 12, wherein the first and second directions are defined to be a vertical direction and a horizontal direction of the window, respectively.

14. The apparatus of claim 8, wherein the first Z-axis signal comprises an information of button.

15. The apparatus of claim 14, wherein the information of button defines a function key or hot key.

16. The apparatus of claim 8, wherein the second Z-axis signal comprises an information of button.

17. The apparatus of claim 16, wherein the information of button defines a function key or hot key.

18. The apparatus of claim 8, wherein the first capacitive touchpad comprises a saw structure thereon.

19. The apparatus of claim 8, wherein the second capacitive touchpad comprises a saw structure thereon.

20. An apparatus comprising:
a keyboard case;
a capacitive touchpad mounted on the keyboard case, and for generating a signal representative of capacitance change in response to a touch thereon; and
a microprocessor within the keyboard case, and connected to the capacitive touchpad for generating a scrolling signal in response to the signal representative of capacitance change.

21. The apparatus of claim 20, wherein the scrolling signal comprises an information of displacement, moving speed, relative position, or continuing and discontinuing time of the touch.

22. The apparatus of claim 20, wherein the scrolling signal comprises an information of scrolling on a window.

23. The apparatus of claim 20, wherein the scrolling signal comprises an information of acceleration of scrolling on a window.

24. The apparatus of claim 20, wherein the scrolling signal comprises an information of button.

25. The apparatus of claim 24, wherein the information of button defines a function key or hot key.

26. The apparatus of claim 20, wherein the capacitive touchpad comprises a saw structure thereon.

27. An apparatus comprising:
a keyboard case;
a first capacitive touchpad mounted on the keyboard case, and for generating a first signal representative of capacitance change in response to a first touch thereon;
a second capacitive touchpad mounted on the keyboard case, and for generating a second signal representative of capacitance change in response to a second touch thereon; and
a microprocessor within the keyboard case, and connected to the first and second capacitive touchpads for generating a vertical scrolling signal in response to the first signal representative of capacitance change and a horizontal scrolling signal in response to the second signal representative of capacitance change, respectively.

28. The apparatus of claim 27, wherein the vertical scrolling signal comprises a first information of displacement, moving speed, relative position, or continuing and discontinuing time of the first touch, and the horizontal scrolling signal comprises a second information of displacement, moving speed, relative position, or continuing and discontinuing time of the second touch.

29. The apparatus of claim 27, wherein the vertical scrolling signal comprises a first information of scrolling on a window in a vertical direction, and the horizontal scrolling signal comprises a second information of scrolling on the window in a horizontal direction.

30. The apparatus of claim 27, wherein the vertical scrolling signal comprises a first information of acceleration of scrolling on a window in a vertical direction, and the horizontal scrolling signal comprises a second information of acceleration of scrolling on the window in a horizontal direction.

31. The apparatus of claim 27, wherein the vertical scrolling signal comprises an information of button.

32. The apparatus of claim 31, wherein the information of button defines a function key or hot key.

33. The apparatus of claim 27, wherein the horizontal scrolling signal comprises an information of button.

34. The apparatus of claim 33, wherein the information of button defines a function key or hot key.

35. The apparatus of claim 27, wherein the first capacitive touchpad comprises a saw structure thereon.

36. The apparatus of claim 27, wherein the second capacitive touchpad comprises a saw structure thereon.

37. An apparatus comprising:
a mouse case;
a first capacitive touchpad mounted on the mouse case, and for generating a first signal representative of capacitance change in response to a first touch thereon;
a second capacitive touchpad mounted on the mouse case, and for generating a second signal representative of capacitance change in response to a second touch thereon; and
a microprocessor within the mouse case, and connected to the first and second capacitive touchpads for generating a first button signal in response to the first signal representative of capacitance change and a second button signal in response to the second signal representative of capacitance change, respectively.

38. The apparatus of claim 37, wherein the first capacitive touchpad is defined to be a left button of a mouse, and the second capacitive touchpad is defined to be a right button of the mouse.

39. The apparatus of claim 38, further comprising a third capacitive touchpad between the first and second capacitive touchpads, and defined to be a middle button of the mouse for generating a third signal representative of capacitance change in response to a third touch thereon, to further generate a third button signal by the microprocessor.

40. The apparatus of claim 39, wherein the third button signal defines a function key or hot key.

41. A apparatus comprising:
a mouse case;
a capacitive touchpad mounted on the mouse case, and having one or more patterns thereon, each of the patterns defined to be a button or a Z-axis for generating a signal representative of capacitance change in response to a touch thereon; and
a microprocessor within the mouse case, and connected to the capacitive touchpad for generating a button signal or a Z-axis signal in response to the signal representative of capacitance change.

42. The apparatus of claim 41, wherein the patterns comprise a left button and a right button of a mouse.

43. The apparatus of claim 42, wherein the patterns further comprises a middle button of the mouse.

44. The apparatus of claim 43, wherein the middle button defines a function key or hot key.

45. The apparatus of claim 41, wherein the patterns comprise a Z-axis of a mouse.

46. The apparatus of claim 45, wherein the Z-axis signal comprises an information of scrolling on a window.

47. The apparatus of claim 45, wherein the Z-axis signal comprises an information of acceleration of scrolling on a window.

48. The apparatus of claim 45, wherein the capacitive touchpad comprises a saw structure thereon.

49. An apparatus comprising:
a keyboard case;
a capacitive touchpad mounted on the keyboard case, and having one or more patterns thereon, each of the patterns defined to be a scrolling mechanism for generating a signal representative of capacitance change in response to a touch thereon; and
a microprocessor within the keyboard case, and connected to the capacitive touchpads for generating a scrolling signal in response to the signal representative of capacitance change.

50. The apparatus of claim 49, wherein the patterns further comprises a left button and a right button of a mouse.

51. The apparatus of claim 50, wherein the patterns further comprises a middle button of the mouse.

52. The apparatus of claim 49, wherein the patterns further comprises one or more function keys or hot keys.

53. The apparatus of claim 49, wherein the scrolling signal comprises an information of scrolling on a window.

54. The apparatus of claim 49, wherein the scrolling signal comprises an information of acceleration of scrolling on a window.

55. The apparatus of claim 49, wherein the capacitive touchpad comprises a saw structure thereon.

56. An apparatus comprising:
a case;
a capacitive touchpad mounted on the case, and serving as an input interface of the apparatus for generating a signal representative of capacitance change in response to a touch thereon; and
a microprocessor within the case, and connected to the capacitive touchpad for generating a Z-axis signal in response to the signal representative of capacitance change.

57. The apparatus of claim 56, wherein the Z-axis signal comprises an information of scrolling on a window in a vertical direction.

58. The apparatus of claim 56, wherein the Z-axis signal comprises an information of scrolling on a window in a horizontal direction.

59. The apparatus of claim 56, wherein the Z-axis signal comprises an information of acceleration of scrolling on a window in a vertical direction.

60. The apparatus of claim 56, wherein the Z-axis signal comprises an information of acceleration of scrolling on a window in a horizontal direction.

61. The apparatus of claim 56, wherein the microprocessor further generates a button signal in response to a second signal representative of capacitance change resulted from a second touch.
